(19) United States
(12) Patent Application Publication
(10) Pub. No.: US 2026/0051776 A1
(43) Pub. Date: Feb. 19, 2026

(54) ELECTRIC MOTOR WITH ROTOR

(71) Applicant: SEW-EURODRIVE GMBH & CO. KG, Bruchsal (DE)

(72) Inventor: Benjamin MAYER, Remchingen (DE)

(73) Assignee: SEW-EURODRIVE GMBH & CO. KG, Bruchsal (DE)

(21) Appl. No.: 19/101,710

(22) PCT Filed: Jul. 12, 2023
(86) PCT No.: PCT/EP2023/069386

§ 371 Date: Feb. 6, 2025

(30) Foreign Application Priority Data
Aug. 8, 2022 (DE) 10 2022 002 860.3

(51) Int. Cl. H02K 1/30; H02K 7/04; H02K 15/027; H02K 15/0273; H02K 15/12

(52) U.S. Cl. CPC H02K 1/30; H02K 7/04; H02K 15/027; H02K 15/0273; H02K 15/12

(57) ABSTRACT

In an electric motor with a rotor, e.g., a rotatably mounted rotor, the rotor has a rotor shaft which protrudes through a recess of a laminated core, the laminated core has a hollow configuration, the recess of the laminated core has a non-round configuration, and the rotor shaft has a circular cylindrical lateral surface in the region covered by the laminated core in the axial direction. A radially protruding shaft collar is molded onto the rotor shaft, the laminated core is positioned against the shaft collar, an annular cavity is arranged in the shaft collar, e.g., is introduced into the shaft collar, a radial bore which passes through the shaft collar opens into the cavity, and adhesive is arranged between the laminated core and the rotor shaft and the annular cavity is at least partly filled with adhesive.

### FIELD OF THE INVENTION

The present invention relates to an electric motor with a rotor.

### BACKGROUND INFORMATION

In certain conventional systems, an electric motor has a rotatably mounted rotor.

German Patent Document No. 10 2020 004 644 describes an electric motor with an active part attached to a shaft.

An electric motor with rotor is described in German Patent Document No. 10 2021 003 896.

An assembly with a shaft-hub connection is described in German Patent Document No. 10 2011 113 876.

A press connection for a rotor shaft is described in Japanese Patent Document No. 2000-232744.

An electric motor with an active part attached to a shaft is described in German Patent Document No. 10 2019 005 666.

A rotor for an electric machine is described in German Patent Document No. 10 2017 214 309.

A rotor for a permanently excited dynamoelectric machine is described in German Patent Document No. 10 2008 027 758.

### SUMMARY

Example embodiments of the present invention provide an electric motor, which is readily producible.

According to example embodiments of the present invention, in an electric motor having a rotor, e.g., a rotatably mounted rotor, the rotor has a rotor shaft which protrudes through a recess in a laminated core. The laminated core has a hollow configuration, and the recess of the laminated core has a non-round configuration. The rotor shaft has a circular cylindrical lateral surface in the region covered by the laminated core in the axial direction, and a radially protruding shaft collar is molded onto the rotor shaft. The laminated core is positioned against the shaft collar, and an annular cavity is arranged in the shaft collar, e.g., is introduced into the shaft collar. A radial bore which passes through the shaft collar opens into the cavity, adhesive is arranged between the laminated core and the rotor shaft, and the annular cavity is at least partly filled with adhesive.

Thus, the laminated core can be pushed towards the shaft collar during production, and adhesive can be fed to the annular cavity through the radial bore, from which cavity the free spaces, e.g., channels, between the laminated core and the shaft can be filled. This is because the non-round configuration of the radial inside of the laminated core creates free spaces when the laminated core is fitted onto the cylindrical shaft, into which free spaces the adhesive can be fed, thus creating the material-locking bond between the shaft and the laminated core.

According to example embodiments, the laminated core has a stack of individual laminations, e.g., in which the stack of individual laminations is punched and packaged, e.g., in which the stack direction is oriented parallel to the axial direction, e.g., parallel to the direction of the axis of rotation of the rotor shaft. Thus, the laminated core can be readily produced as a stack. Alternatively, the stack is bonded in a material-locking manner, e.g., via adhesive and/or bonding varnish.

According to example embodiments, channels extending, e.g., passing through, in the axial direction are formed between the rotor shaft and the laminated core, which channels open into the annular cavity. Thus, the channels can be formed by the non-round configuration of the individual laminations and thus the material-locking bond can be effected.

According to example embodiments, a further radially directed bore, e.g., a radial bore, passing through the shaft collar opens into the cavity. For example, the further bore is arranged 180° away from the radial bore in the circumferential direction, and the further bore covers the same radial distance region as the radial bore. Thus, unbalance can be reduced, e.g., if the radial bore takes the same amount of material out of the shaft collar as the further bore. In addition, a more even filling of the channels with adhesive is possible.

According to example embodiments, the region covered by the shaft collar in the axial direction includes the region covered by the annular cavity in the axial direction. Thus, the cavity can be produced as a puncture. Thus, ready production is made possible by puncturing with a turning tool.

According to example embodiments, permanent magnets are arranged and/or fastened on the radial outer circumference of the laminated core. Thus, the motor can be arranged as a synchronous motor.

According to example embodiments, the laminated core is pushed onto and/or fitted onto the rotor shaft. Thus, ready production is made possible by pushing onto and/or fitting onto.

According to example embodiments, the channels are spaced apart from one another in the circumferential direction, e.g., evenly spaced apart. Thus, the connecting force is evenly distributed.

According to example embodiments, the radially inner boundary of the cavity, e.g., the smallest radial distance of the cavity, has a monotonically, e.g., strictly monotonically, decreasing radial distance value as the distance to the laminated core increases in the axial direction. Thus, the puncture is made at an angle, e.g., not in a purely axial or purely radial direction. Thus, as the depth of the puncture increases, the radial distance to the rotatably mounted shaft becomes smaller and the distance to the laminated core becomes larger.

According to example embodiments, the radially outer boundary of the cavity, e.g., the largest radial distance of the cavity, has a monotonically, e.g., strictly monotonically, decreasing radial distance value as the distance to the laminated core increases in the axial direction. Thus, the annular cavity has an axial region in which the largest radial distance of the cavity in relation to the axis of rotation of the rotor shaft becomes smaller, i.e., decreases monotonically, e.g., strictly monotonically, as the distance from the laminated core increases.

According to example embodiments, the distance between the largest and the smallest radial distance of the cavity is independent of the axial position, e.g., is constant, at least in an axial partial region. Thus, the ring width of the annular cavity measured perpendicular to the outer contour of the annular cavity is constant.

According to example embodiments, the annular cavity is formed extending around completely and/or without interruption in the circumferential direction. Thus, the adhesive can be provided in all circumferential angle positions for channels and gaps arranged between the rotor shaft and laminated core, since the cavity is present at every circumferential position and adhesive is thus allowed to escape from it to the laminated core.

According to example embodiments, the ring axis of the annular cavity is oriented coaxially to the axis of rotation of the rotor shaft. Thus, an even adhesive distribution in the circumferential direction is possible.

According to example embodiments, the laminated core touches the shaft collar. Thus, the shaft collar is arranged as an axial stop and thus also contributes to the axial positioning of the laminated core.

According to example embodiments, a seal is arranged between the laminated core and the shaft collar, which seal is arranged radially outside the channels, the annular cavity, and/or the puncture. Thus, the adhesive penetrates from the cavity into the channels between the laminated core and the rotor shaft, but does not escape into the external environment.

According to example embodiments, the annular cavity has a trapezoidal cross-section, e.g., a rectangular trapezoidal cross-section. Thus, the radially outer and radially inner boundaries are arranged at a constant distance from each other, thus making it possible to produce by puncture with a tool, e.g., a turning tool.

According to example embodiments, the radial distance region covered by the shaft collar includes the radial distance region covered by the laminated core. Thus, the cavity and its mouth facing the laminated core are arranged within the radial distance region of the laminated core. An escape of the adhesive into the external, e.g., radially external, environment is thus prevented.

According to example embodiments, the individual laminations of the laminated core are formed such that the mouth opening of the channel closest to the respective radial bore or bore in the circumferential direction and/or counter to the circumferential direction has a smaller cross-sectional area than the mouth opening of a channel arranged further away in the circumferential direction or counter to the circumferential direction, and the cross-sectional area of the channel closest to the respective radial bore or bore in the circumferential direction and/or counter to the circumferential direction increases monotonically, e.g., strictly monotonically, in the axial direction with increasing distance from the shaft collar. Thus, the production of the laminated core is readily performed. This is because only the first individual lamination needs to have correspondingly smaller recesses, which can be achieved in the punching machine using a controllable tool. The first individual lamination thus has, e.g., first individual lamination have, the narrowed mouth openings facing the cavity. The further individual laminations provide the larger channel cross-section. Thus, the distribution of the adhesive around the circumference is homogenized.

Further features and aspects of example embodiments of the present invention are explained in more detail with reference to the appended schematic Figures.

### BRIEF DESCRIPTION OF THE DRAWINGS

FIG. 1 is an exploded perspective view of a rotor of an electric motor.

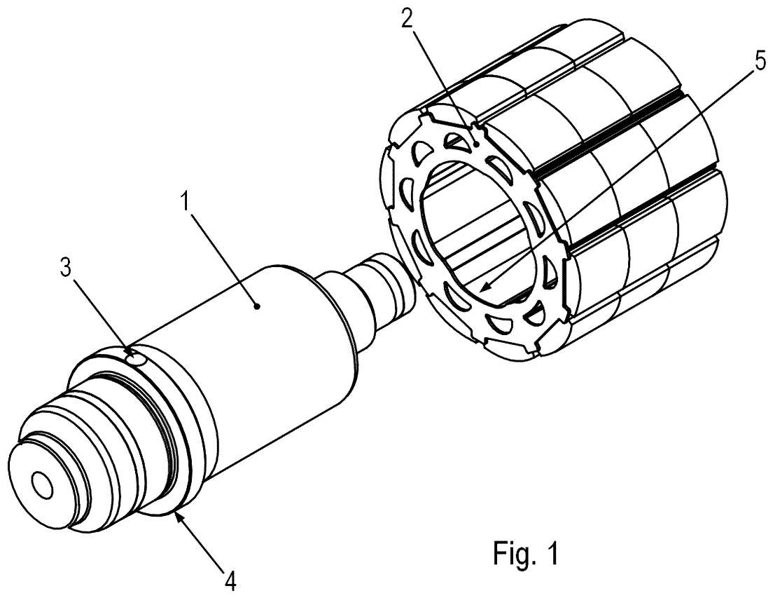

FIG. 2 is a side view of a rotor shaft 1 of the rotor.

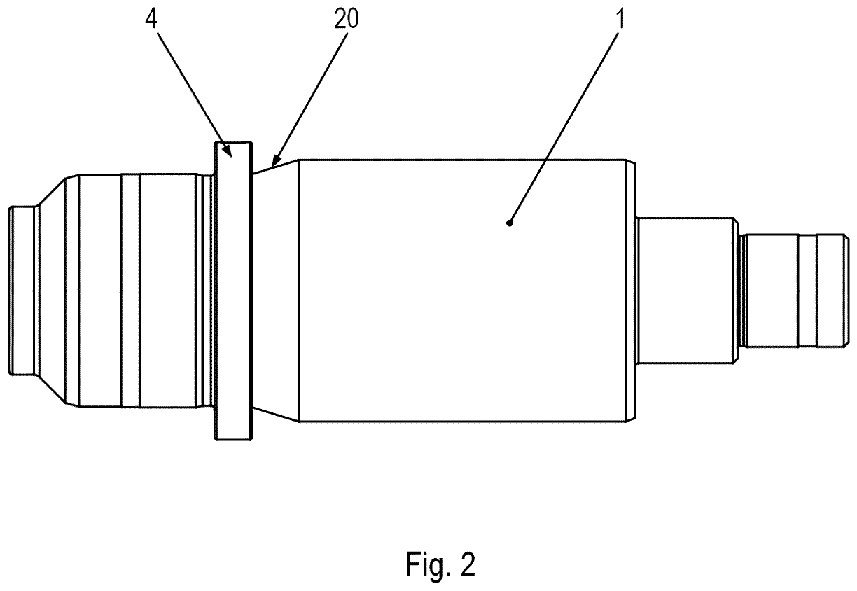

FIG. 3 is a longitudinal cross-sectional view through the rotor.

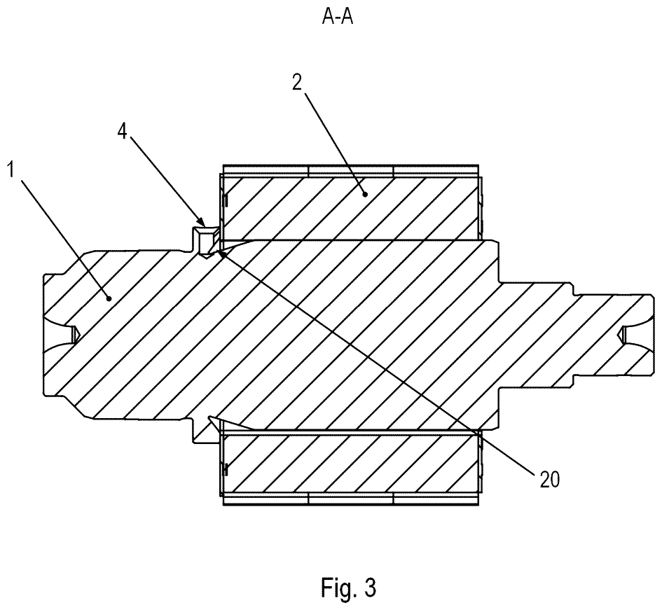

FIG. 4 is an enlarged cross-sectional view through the rotor.

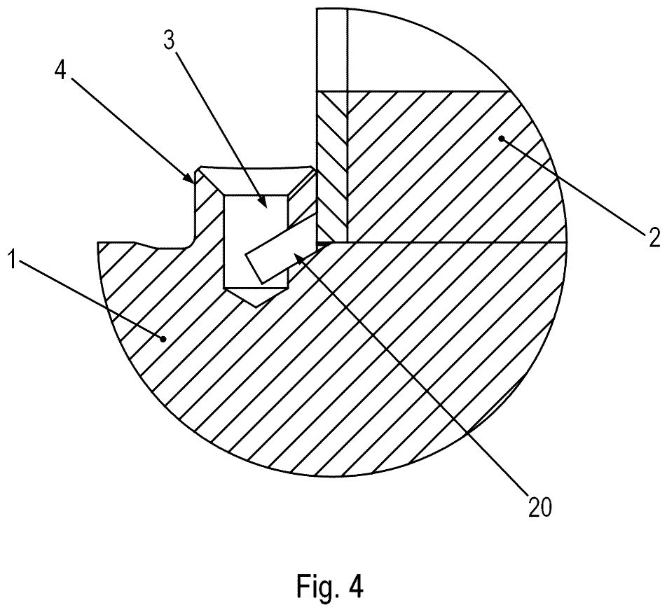

### DETAILED DESCRIPTION

As illustrated in the Figures, the rotor of the electric motor has a rotor shaft 1 onto which a laminated core 2 is fitted.

The laminated core 1 is, for example, produced as a punched and packaged stack of individual laminations.

The rotor shaft 1 is fitted into the laminated core with play, in which a material-locking connection is provided between the shaft 1 and the laminated core 2, e.g., by adhesive being interposed.

For this purpose, the inner circumference of the laminated core 2 is not arranged as the lateral surface of a circular cylinder, but has radially directed projections which are spaced apart from one another in the circumferential direction, e.g., regularly spaced apart from one another. Hence, the smallest radial distance of the laminated core is dependent on the circumferential angle, e.g., it is thus a non-vanishing periodic function of the circumferential angle.

However, since the laminated core is fitted onto a section of the rotor shaft 1 which resembles a lateral surface of a circular cylinder, axially extending channels are formed between the laminated core 2 and the rotor shaft 1, into which the adhesive can be introduced, which creates a material-locking connection between the laminated core 2 and the rotor shaft 1.

For the purpose of introducing the adhesive, a radially projecting shaft collar 4 is formed on the shaft 1, which shaft collar 4, e.g., extends around radially without interruption in the circumferential direction.

### The Axial Direction Is Parallel to the Direction of the Axis of rotation of the shaft. The radial direction and the circumferential direction are also related to this axis of rotation.

On the one hand, the shaft collar 4 is arranged as an axial stop for a bearing whose inner ring is fitted onto the shaft. The bearing, e.g., the inner ring of the bearing, is thus bounded in the axial direction.

In addition, the shaft collar is also arranged as a stop for the laminated core 2, which is arranged on the side of the shaft collar 4 facing away from the bearing.

Furthermore, a radial bore 3 is made in the shaft collar 4, e.g., on the outer circumference of the shaft collar 4, which radial bore 3 leads to a lubricant supply introduced in a tube-like cavity. This cavity is bounded by the shaft collar 4 of the rotor shaft 1 and by the laminated core 2.

The cavity is produced by turning with a machining tool, e.g., a turning tool, which is punctured into the material of the shaft collar 4 at an angle of between 20° and 45°, e.g., at an angle of 30°, to the axis of rotation of the rotor shaft 1.

The cavity is uninterrupted in the circumferential direction. The radial bore 3 opens into the cavity.

The channels created by the radial projections also open into the tube-like cavity.

Thus, during production, liquid adhesive can initially still be supplied to the tubular cavity through the radial bore 3, from which cavity the axially extending channels arranged between laminated core 2 and rotor shaft 1 are supplied with adhesive.

After the adhesive has hardened, it remains in the channels as well as in the tubular cavity arranged in the shaft collar 4. In this manner, the axial positioning of the laminated core 2 on the rotor shaft 1 is also fixed, e.g., relative to the shaft collar 4.

To produce the tube-like cavity, a puncture is made, e.g., with the above-mentioned tool, which puncture extends so far into the shaft collar 4 that the radial bore 3 opens into the tube-like cavity.

The tube-like cavity has the shape of a ring whose ring axis is oriented coaxially to the axis of rotation of the shaft.

Thus, the region covered by the puncture and/or the tube-like cavity in the axial direction overlaps with or includes the region covered by the radial bore 3 in the axial direction.

The radial distance region covered by the tube-like cavity overlaps with the radial distance region covered by the radial bore, e.g., the radial distance is related to the axis of rotation of the shaft.

### The Inner Ring of the Bearing Is Fitted Onto the Rotor Shaft 1. For example, the bearing, e.g., the inner ring, is arranged on the side of the shaft collar the laminated core 2.

The cross-section, e.g., the annular cross-section, of the tube-like cavity is rectangular, e.g., in which one side of the rectangle has an angle of between 20° and 45°, e.g., an angle of 30°, to the axis of rotation of the rotor shaft 1. The rectangular cross-section opens into the environment of the rotor shaft 1 on the side axially facing away from the bearing, i.e., towards the laminated core. The mouth opening of the tubular cavity is thus covered by the laminated core 2 or merges into the channels formed between the laminated core 2 and the rotor shaft 1.

An Undercut Is Formed via the Tubular Cavity.

The depth of the incision in the material of the shaft collar 4 is such that the volume of the tubular cavity has a specified value.

The sectional plane of the cross-section of the tubular cavity contains the axis of rotation of the rotor shaft 1.

An indexable insert can be used as a turning tool. For example, the tubular and/or annular cavity can be created via axial grooving with this indexable insert.

For example, the adhesive may be activated by light. In this manner, seals between the shaft collar and laminated core can be omitted.

For example, a rounded elongated cross-section may be used instead of the rectangular cross-section.

For example, an adhesive bond and/or a bond with bonding varnish is carried out instead of the punching and packaging of the stack.

For example, instead of fitting the rotor shaft into the laminated core with play, the laminated core is pressed in with almost or completely disappearing play and is thus connected to the laminated core 2 in a force-locking manner. The adhesive connection is an additional connection so that a high level of safety can be achieved.

For example, a further radial bore through the shaft collar 4 is provided in order to compensate for the unbalance and to achieve a more even filling of the channels.

For example, those channels which are closest to the radial bore in the circumferential direction or counter to the circumferential direction are provided with an opening narrowed towards the cavity, in that at least the individual lamination closest to the shaft collar 4, i.e., the first individual lamination of the stack of laminations, has correspondingly minimized openings for the respective channel. Thus, the distribution of the adhesive fed into the cavity at high pressure via the radial bore is homogenized.

### List of Reference Numerals

1 Rotor shaft
2 Laminated core
3 Radial bore
4 Shaft collar
5 Inner circumference of the laminated core 2
20 Puncture

1-15. (canceled)

16. An electric motor, comprising:
a rotor having a rotor shaft that protrudes through a recess of a laminated core, the laminated core having a hollow configuration, the recess of the laminated core having a non-round configuration, the rotor shaft having a circular cylindrical lateral surface in a region covered by the laminated core in an axial direction;
wherein a radially protruding shaft collar is molded on the rotor shaft, the laminated core being positioned against the shaft collar;
wherein an annular cavity is arranged in the shaft collar;
wherein a radial bore that passes through the shaft collar opens into the cavity; and
wherein adhesive is arranged between the laminated core and the rotor shaft, and the annular cavity is at least partly filled with adhesive.

17. The electric motor according to claim 16, wherein the laminated core includes a stack of individual laminations.

18. The electric motor according to claim 17, wherein the stack of individual laminations is punched and packaged, and a stack direction is oriented parallel to the axial direction and/or parallel to a direction of an axis of rotation of the rotor shaft.

19. The electric motor according to claim 16, wherein a further radially directed bore passing through the shaft collar opens into the cavity.

20. The electric motor according to claim 19, wherein the further radially directed bore is arranged 180° away from the radial bore in a circumferential direction and covers a same radial distance region as the radial bore.

21. The electric motor according to claim 16, wherein channels extending in the axial direction are arranged between the rotor shaft and the laminated core and open into the annular cavity.

22. The electric motor according to claim 16, wherein a region covered by the shaft collar in the axial direction includes a region covered by the annular cavity in the axial direction.

23. The electric motor according to claim 16, wherein permanent magnets are arranged and/or fastened on a radial outer circumference of the laminated core.

24. The electric motor according to claim 16, wherein the laminated core is pushed onto and/or fitted onto the rotor shaft.

25. The electric motor according to claim 21, wherein the channels are spaced apart and/or evenly spaced apart from one another in a circumferential direction.

26. The electric motor according to claim 16, wherein a radially inner boundary of the cavity and/or a smallest radial distance of the cavity has a monotonically and/or strictly monotonically decreasing radial distance value as distance to the laminated core increases in the axial direction.

27. The electric motor according to claim 16, wherein a radially outer boundary of the cavity and/or a largest radial distance of the cavity has a monotonically and/or strictly monotonically decreasing radial distance value as distance to the laminated core increases in the axial direction.

28. The electric motor according to claim 16, wherein a distance between a largest and a smallest radial distance of the cavity is independent of axial position and/or constant at least in an axial partial region.

29. The electric motor according to claim 16, wherein the annular cavity extends around completely and/or without interruption in a circumferential direction.

30. The electric motor according to claim 16, wherein a ring axis of the annular cavity is oriented coaxially to an axis of rotation of the rotor shaft.

31. The electric motor according to claim 16, wherein the laminated core touches the shaft collar.

32. The electric motor according to claim 16, wherein a seal is arranged between the laminated core and the shaft collar and is arranged radially outside the annular cavity and/or channels that extend in the axial direction, that are arranged between the rotor shaft and the laminated core, and that open into the annular cavity.

33. The electric motor according to claim 16, wherein the annular cavity has a trapezoidal and/or a rectangular trapezoidal cross-section.

34. The electric motor according to claim 16, wherein a radial distance region covered by the shaft collar includes a radial distance region covered by the laminated core.

35. The electric motor according to claim 17, wherein the individual laminations of the laminated core are formed such that a mouth opening of a channel closest to a respective radial bore in a circumferential direction and/or counter to the circumferential direction has a smaller cross-sectional area than a mouth opening of a channel arranged further away in the circumferential direction or counter to the circumferential direction, and a cross-sectional area of a channel closest to the respective radial bore in the circumferential direction and/or counter to the circumferential direction increases monotonically and/or strictly monotonically in the axial direction as distance from the shaft collar increases.
